(19) United States
(12) Patent Application Publication
(10) Pub. No.: US 2022/0404817 A1
(43) Pub. Date: Dec. 22, 2022

(54) PROCESSES FOR CONTROLLING OPERATION OF MACHINE TOOLS

(71) Applicant: On-Time.AI, Inc., Dallas, TX (US)

(72) Inventor: Michael L. George, SR., Dallas, TX (US)

(21) Appl. No.: 17/839,925

(22) Filed: Jun. 14, 2022

Related U.S. Application Data
(60) Provisional application No. 63/211,848, filed on Jun. 17, 2021.
(60) Provisional application No. 63/296,381, filed on Jan. 4, 2022.

(51) Int. Cl. G05B 19/418; G05B 19/4063

(52) U.S. Cl. CPC G05B 19/41865; G05B 19/4063; G05B 19/4183

(57) ABSTRACT

Methods, systems and apparatus, including computer programs encoded on computer storage medium, for processing multiple jobs using a plurality of workstations. The plurality of workstations are grouped into multiple Pull groups, each Pull group including one or more workstations of a same type. The processing includes, repeatedly, at each of multiple time steps until a predetermined condition is satisfied: collecting, using sensors that monitor the plurality of workstations, sensor data from Pull groups in the multiple Pull groups; computing, for each of the multiple jobs, a current remaining lead time using the collected sensor data and Little's Law; and adjusting, based on the computed current remaining lead times, priorities at which the multiple jobs are processed by each Pull group.

### CROSS-REFERENCE TO RELATED APPLICATIONS

This application claims the benefit of U.S. Provisional Application Ser. No. 63/296,381, filed Jan. 4, 2022, and U.S. Provisional Application Ser. No. 63/211,848, filed Jun. 17, 2021, the contents of which are incorporated by reference.

### TECHNICAL FIELD

This specification generally relates to controlling operations of machine tool workstations and controlling operations of workstations in supply chains, logistics, and new product development processes.

### BACKGROUND

Machine shops contain raw materials, such as bar stock for machining, which are processed by machine tools to create an inventory of finished parts that can be provided for use in the machining industry, semiconductor industry, automotive industry, aerospace and defense industry or others. Finished parts are work pieces that meet specifications set out for the work piece by engineering drawings, blue prints, or digital information.

Machines tools in a machine shop are used for shaping or machining metals or other materials to manufacture a variety of different finished parts. Manufacturing different parts in a machine shop typically requires multiple change overs or setup processes of the machine tools to change part types. Each setup process is then followed by cutting, boring, grinding, shearing or other methods of deformation. For example, in semiconductor manufacturing changes in part types can require repeatedly setting up a machine tool to perform different processes such as photolithography, wet etching, or dry etching. As another example, in the printing industry changing wallpaper types can require changing out a large rotogravure cylinder and ink color matching, followed by cleaning and inspection in preparation for the next use.

Most manufacturing industries are adversely affected by setup time. Setup time is generally considered waste time. The longer the setup time, the larger the batch size of subsequent production is required to make the process profitable. This in turn can create substantial finished goods inventory which may never be sold. In addition, the number of different products needed to compete in most markets is growing rapidly, in many industries by nearly 20% per annum, which reduces required repetition frequency per product. This in turn causes engineering-intensive methods for reducing setup time to become ineffective.

### SUMMARY

This specification describes methods and systems for implementing on-time processes to control the operation of workstations in manufacturing, supply chains, logistics, and new product development.

Innovative aspects of the subject matter described in this specification can be embodied in methods that include processing multiple jobs using a plurality of workstations, wherein the plurality of workstations are grouped into multiple Pull groups, each Pull group comprising one or more workstations of a same type, the processing comprising, repeatedly, at each of multiple time steps until a predetermined condition is satisfied: collecting, using sensors that monitor the plurality of workstations, sensor data from Pull groups in the multiple Pull groups; computing, for each of the multiple jobs, a current remaining lead time using the collected sensor data and Little's Law; and adjusting, based on the computed current remaining lead times, priorities at which the multiple jobs are processed by each Pull group.

Other embodiments of this aspect include corresponding computer systems, apparatus, and computer programs recorded on one or more computer storage devices, each configured to perform the actions of the methods. A system including a collection of machine tool workstations used to process a plurality of parts; one or more computers in data communication with the collection of machine tool workstations; and a computer-readable medium coupled to one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations the multiple time steps correspond to predetermined time intervals, wherein the predetermined time intervals comprise a same duration, optionally wherein the same duration is determined based on an average machining time per job for the plurality of workstations.

In some implementations, at each of the multiple time steps, sensor data is collected from each Pull group or from a subset of the multiple pull groups.

In some implementations the multiple time steps correspond to times at which stages of the processing of the multiple jobs are completed.

In some implementations the multiple time steps correspond to predetermined time intervals, wherein the predetermined time intervals vary for each of the multiple pull groups, optionally wherein a time interval corresponding to a respective pull group is determined based on an average machine time per job for the pull group.

In some implementations a frequency of the multiple time steps is based on one or more of a target accuracy of the remaining lead times and system computational capability.

In some implementations the method further comprises receiving, at one or more of the multiple time steps, a trigger signal from one or more sensors that monitor respective workstations in real time, wherein the trigger signal is sent by the one or more sensors in response to the one or more sensors detecting an unexpected event or operational status; and in response to receiving the trigger signal, collecting sensor data from pull groups that include respective workstations, computing a current remaining lead time using the collected sensor data and Little's Law, and adjusting priorities at which the multiple jobs are processed by each Pull group.

In some implementations the method further comprises one or more of: obtaining production control data and accounting data and computing, for each of the multiple jobs, a current remaining lead time using the obtained production control data and accounting data; or obtaining transport data, the transport data comprising data indicating current traffic conditions, data indicating current weather conditions, data indicating available transport services, or data indicating a historical reliability of transport services, and computing, for each of the multiple jobs, a current remaining lead time using the obtained transport data.

In some implementations the predetermined condition is satisfied when each of the multiple jobs has been completed.

In some implementations computing a current remaining lead time for a job using the collected sensor data and Little's Law comprises: determining, using the sensor data and Little's Law, a current average delay time at each Pull group; and estimating, using the current average delay time at each Pull group, a lead time for the job.

In some implementations determining, using the sensor data and Little's Law, a current average delay time at each Pull group comprises: computing a number of jobs in WIP using the sensor data and determining the current average delay time at each Pull group using Little's law and the computed number of jobs in WIP; or computing a number of jobs in WIP using a Pollaczek-Khintchine equation and determining the current average delay time at each Pull group using Little's law and the computed number of jobs in WIP.

In some implementations the Pollaczek-Khintchine equation relates a current number of jobs in process with variables comprising utilization percentage, a number of cross trained resources, rework percentage, a variation of time to perform jobs and a variation of the arrival of jobs.

In some implementations determining, using the sensor data and Little's Law, a current average delay time at each Pull group comprises: computing a standard deviation of the current delay time; determining whether the standard deviation exceeds a predetermined acceptable threshold; in response to determining that the standard deviation does not exceed the predetermined acceptable threshold: computing a number of jobs in WIP using the sensor data; and determining the current average delay time at each Pull group using Little's law and the computed number of jobs in WIP; or in response to determining that the standard deviation does not exceed the predetermined acceptable threshold: computing a number of jobs in WIP using a Pollaczek-Khintchine equation; and determining the current average delay time at each Pull group using Little's law and the computed number of jobs in WIP.

In some implementations computing a current remaining lead time for a job using the collected sensor data and Little's Law further comprises: determining, using the current remaining lead time, an estimated completion time for the job; and comparing the estimated completion time for the job to a target completion time for the job to determine a current delay for the job.

In some implementations adjusting, based on the computed current remaining lead times, priorities at which the multiple jobs are processed by each Pull group comprises: identifying one or more jobs that will not meet respective target completion times; and assigning the identified one or more jobs higher processing priorities at one or more subsequent Pull groups.

In some implementations the number of multiple Pull groups is dependent on properties of the plurality of workstations, wherein the properties of the workstations comprise one or more of i) location of workstation, ii) an acceptable uninterrupted workstation runtime.

In some implementations each Pull group is configured to receive a constrained number of days of work in progress per batch of parts, wherein the number of days depends on an average setup and machining time per part over each workstation in the Pull group.

In some implementations each workstation is associated with a set of performance parameters, the set comprising workstation setup time and part delivery time.

In some implementations collecting the sensor data, computing the current remaining lead times, and adjusting the priorities at which the multiple jobs are processed by each Pull group are performed by one or more local computers or by an external cloud service provider.

In some implementations the sensor data from a Pull group comprises i) data representing a number of jobs currently processed by or queued at the Pull group and ii) data representing a current rate of the number of jobs exiting the Pull group.

Innovative aspects of the subject matter described in this specification can also be embodied in methods for processing multiple jobs or tasks, the processing comprising: collecting, using sensors that monitor the multiple jobs or tasks in real time, sensor data from the multiple jobs or tasks; and repeatedly, at each of multiple time steps: calculating, for each of the multiple jobs or tasks and using the sensor data, a remaining lead time using Little's Law; and adjusting, using the remaining lead times, priorities at which the multiple jobs or tasks are processed.

The foregoing and other embodiments can each optionally include one or more of the following features, alone or in combination. In some implementations the multiple jobs or tasks comprise jobs or tasks in a manufacturing process, supply chain, logistics, or new product development process.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

Innovative aspects of the subject matter described in this specification can also be embodied in methods that include receiving a request to produce a quantity of finished goods, wherein producing the quantity of finished goods comprises processing multiple jobs; calculating, for each job of the multiple jobs and for each of multiple available factories, a remaining lead time using Little's Law; selecting, based on the calculated remaining lead times and for each job of the multiple jobs, a factory with a lowest lead time; and routing each job of the multiple jobs to a respective selected factory for processing.

The foregoing and other embodiments can each optionally include one or more of the following features, alone or in combination. In some implementations multiple factories share a lowest lead time, and the method further comprises: selecting, from the multiple factories that share the lowest lead time, a factory with a highest spare production capacity; and routing the corresponding job of the multiple jobs to the factory with the highest spare production capacity for processing.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

The subject matter described in this specification can be implemented in particular embodiments so as to realize one or more of the following advantages.

In many manufacturing processes, e.g., job shop manufacturing, parts produced do not follow identical flow patterns. When a sequence of production follows a customer schedule date, the setup of workstation tools and geometry of a part may not match an existing setup, requiring a change of setup. Changing between setups can take a long time and is a waste of machinist labor, resulting in reduced efficiency and increased costs of the machine shop.

A system implementing the techniques described in this specification can achieve significant improvements in on-time performance and efficiency. In particular, a system running the presently described on-time solution software develops Pull groups of like machines and implements a WIP control Pull system to control the maximum number of Jobs at each Pull Group. Little's Law is used to dynamically calculate remaining lead time for each job's router and potentially late jobs are re-prioritized to be on-time. Each job at each machine (or at each Pull group) is dynamically sequenced, e.g., every 15 minutes, to minimize setup time. Accordingly, on-time performance has been observed to increase, e.g., from 54% to 98%, EBITDA has been observed to increase, e.g., from −3.6% to +19% and customer trust has been observed to increase revenue, e.g., by 20%.

The techniques described in this specification are described using the example of reducing machine tool workstation set up time in a manufacturing process, however the techniques can be applied to reduce the set up time of any process steps in any manufacturing process. For example, some manufacturing processes can include operations that require setup sequencing but are not performed by machine tool workstations, e.g., operations performed by a paint booth, semiconductor photolithography, dry etch, or wet etch which vary from 10 minutes to 4 hours. In addition, the techniques described in this specification can also be applied in other settings. For example, the techniques can be applied to reduce other performance measures in a manufacturing process, e.g., to reduce waste or machine downtime. As another example, the techniques can be applied in other processes that are effected by setup time, e.g., semiconductor manufacturing processes, procurement processes, or surgical preparation processes.

The presently described techniques have been applied to a real-world factory which machines parts for commercial aerospace and defense requirements. Most factories operate under the assumption that “the sooner we put the job onto the shop floor, the sooner we will get it finished”. In fact, Little's Law indicates that doubling the Work In Process with double the time to complete the product, jeopardizing on-time delivery per Little's Law. Current scheduling systems do not use Little's Law. Further, current scheduling systems use static standards data and do not use real time data (which includes current processing rates, setup time, machine downtime, scrap and rework). Accordingly, current scheduling systems achieve about 50% on-time performance. In fact, the real world machine shop described above was only 54% on-time. After it deployed the presently described techniques, it's on time performance increased to 98%.

The details of one or more embodiments of the subject matter of this specification are set forth in the description below. Other features, aspects, and advantages of the subject matter will become apparent from the description and the claims.

### DESCRIPTION OF DRAWINGS

FIG. 1 is a block diagram of an example job shop.

FIG. 2 is a block diagrams of an exemplary system.

FIG. 3 is a flowchart of an example process for processing parts using multiple machine tool workstations.

FIG. 4 is a graph that shows the impact of the Pollaczek-Khintchine equation on task time.

FIG. 5 is a block diagram of example pull groups and example paths of parts generated based on dynamically calculated minimum cycle times.

FIG. 6 is a flowchart of an example process for processing multiple jobs or tasks.

FIG. 7 is a flowchart of an example process for processing multiple jobs or tasks in a supply chain.

FIG. 8 shows an example GUI.

FIG. 9 is a schematic diagram of an exemplary system.

Like reference symbols in the various drawings indicate like elements.

### DETAILED DESCRIPTION

### Introduction

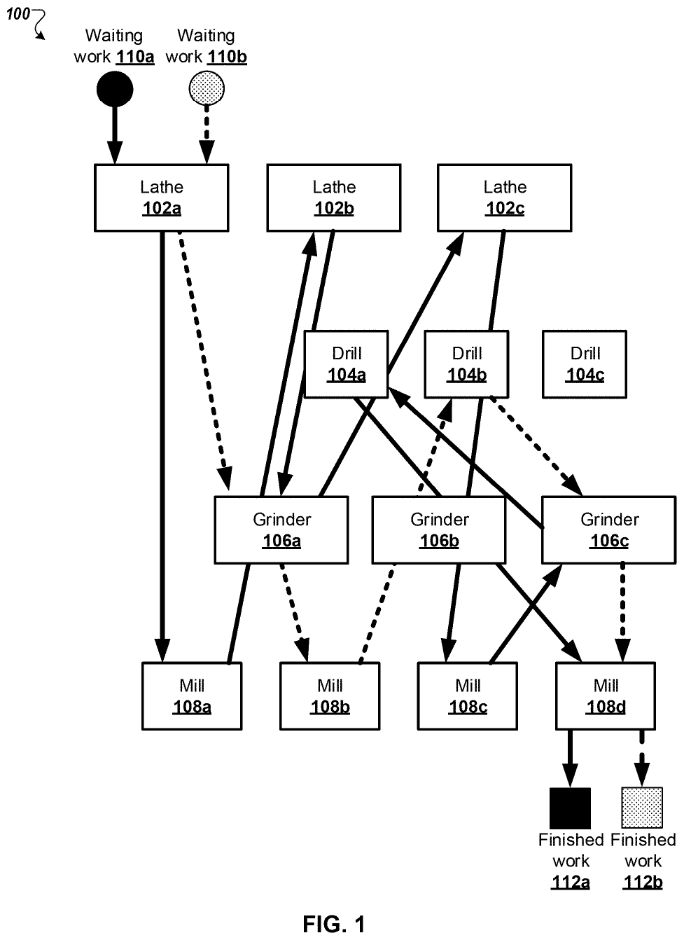

Job shops are small manufacturing systems that perform customized or semi-customized manufacturing processes such as small to medium-size customer orders or batch jobs. FIG. 1 is a block diagram of an example job shop 100. The example job shop 100 includes multiple machine workstations that process waiting work, e.g., waiting work 110a-b, to produce finished work, e.g., finished work 112a-b. The example job shop 100 is depicted as including three lathes 102a-c, three drills 104a-c, three grinders 106a-c, and four mills 108a-d, however this is for illustrative purposes only and the job shop could include fewer or additional machine workstations.

During a job shop manufacturing process, produced products do not follow identical flow patterns—their routes through the job shop differ. FIG. 1 shows two example flow patterns that produce finished work 112a and 112b. The first flow pattern uses lathe 102a to process waiting work 110a. The processed waiting work 110a is then processed in sequence by mill 108a, lathe 102b, grinder 106a, lathe 102c, mill 108c, grinder 106, drill 104a, and mill 108d to produce finished work 112a. The second flow pattern uses lathe 102a to process waiting work 110b. The processed waiting work 110b is then processed in sequence by grinder 106a, mill 108b, drill 104b, grinder 106c, and mill 108d to produce finished work 112b.

When a sequence of production follows a customer schedule date sequence, a required setup of machine tools and a geometry of a part will generally not match the existing setup, requiring many hours for the setup changeover. In addition, there can be many different paths or routes through different machines in the factory. Typically, factories implement fixed paths which can have a larger amount of WIP than an alternative, which leads to longer manufacturing cycle time. In addition, most job shops include at least one machine whose capabilities are identical to another machine. Therefore, even if a part number has an identical router to a previous one in the production sequence, it can be routed to A not B, or vice versa. For example, in the first flow pattern shown in FIG. 1, grinders 106a and 106b could have identical capabilities. In this example a first part number, e.g., corresponding to waiting work 110a, could be routed from lathe 102b to grinder 106a to lathe 102c, whereas a second part number corresponding to other waiting work could be routed from lathe 102b to grinder 106b to lathe 102c.

In these cases both the first part number and second part number could eventually produce identical finished work. However, a major setup requiring many hours can ensue if it happens to be routed to the machine whose prior setup is a poor match. Furthermore, because the routings of part numbers can be different in job shop manufacturing, when material is released into the production process it cannot be accurately predicted when the material (or rather the corresponding processed part) will emerge. It has been said that “[w]hen we chart the flow of the material through a facility it ends up looking like a randomly tossed bowl of spaghetti . . . Product is moving everywhere. There is no coordination of the product across departments. No amount of scheduling can control the inherent variation in the system when that system causes materials to move in every which way.” Therefore, in job shop manufacturing there are very long setup times which are a waste of machinist labor, and little control over the delivery lead time resulting in poor on-time delivery.

Known attempted solutions to the job shop manufacturing problem of how to reduce setup times include large batch techniques, sequencing without regard for on-time delivery, and applications of mathematical models (which can incorporate heuristics to avoid complex combinatorial computations). Large Batch techniques attempt to compensate for the problem of setup waste by building a large batch of each part number which will satisfy a year's demand. Such large batches are generally far beyond the quantity immediately needed by the customer. The long setup time is amortized over the large batch, most of the cost goes into inventory, hence the short-term profitability appears to be acceptable. However, inevitably this process leads to inventory write-downs and losses, as customers either fail to purchase the projected demand, or the customer issues a revised spec of the part number and the products in inventory must be scrapped or reworked. In addition, producing a batch to satisfy a year's demand ties up the respective machine workstations for a long period, delaying the production of other products to the detriment of on-time delivery.

Sequencing without regard for on-time delivery produces part numbers in a sequence which minimizes setup waste. For example, if a machine tool must change the diameter of bar stock being machined, a chuck change-over can take more than an hour. This problem could be addressed by starting the week on Monday by producing all the different products that used 2 inch diameter bar stock, then changing the chuck to 3 inches and running all those products, and ending the week with all products requiring 4 inch bar stock. However, this sequencing can incur significant delivery time delays. Further, the setup time reduction is limited to the time saved for chuck changes, and fails to sequence in relation to tool changes. For example, a two turret 24 tool lathe can require 29 hours to change over all tools, a waste that cannot be avoided by only reducing chuck change time.

Applications of mathematical models includes formulating the job shop manufacturing problem as follows: assume that a given factory is to produce N different part numbers, and that the factory contains M different machine workstations. There are N choices for selecting the part to be run first, N−1 choices for the second part, etc. There are therefore N! total sequences in the production schedule. There are also M permutations of machine workstations on which to run the parts. Therefore, the total number of possible production sequences in which parts can be run is {S}=(N!)^{M}. The goal is to find the production sequence of running parts which results in 1) lowest waste cost, and 2) a predetermined success rate of on-time delivery, e.g., 95% on-time delivery. As a working example, assume N=10, M=1. In this example, determining the production sequence of parts that minimizes cost and meets the predetermined success rate of on-time delivery involves the infeasible (or at least computationally inefficient) task of evaluating 10!≈3.6 million sequences of 10 part numbers to see which sequence results in the lowest total setup time/cost. Heuristics can be applied to avoid this combinatorial computation, however the application of heuristics typically cannot guarantee the on-time delivery of part numbers and heuristics are typically not used to schedule a factory. Rather, real job shops set up machine workstations and build parts in a sequence based on customer delivery dates. These sequences are effectively random sequences with respect to setup time, resulting in huge setup time and capacity waste. Little or no consideration of reducing setup time by exploiting common geometry and tooling is applied.

Further, the job shop manufacturing problem described above (and illustrated in FIG. 1) applies to a single factory or machine shop. The job shop manufacturing problem becomes even more complex and challenging when an entire manufacturing process or supply chain is considered. For example, some supply chains have hundreds of factories or services, where each factory or service can receive input materials from an upstream supply chain input and supply finished goods to a downstream factory, warehouse, logistics distribution center, or customer who has requested a product to be delivered on-time according to their schedule. Further, at each step of the supply chain it is likely that the order can be produced or handled by more than one of these factories or services, increasing the complexity of determining a sequence of factories and services that meets a target delivery time with reduced setup waste.

### Overview

This specification describes methods and systems, including computer programs encoded on computer storage media, for implementing on-time processes in job shops, supply chains, logistics and product development. Little's Law is used to dynamically calculate remaining lead times for active jobs and jobs that are currently behind schedule are reprioritized to be completed on-time. The accuracy of the calculated remaining lead times can be improved through application of a Pollaczek-Khintchine equation.

For convenience, the methods and systems are described in the context of controlling operations of machine tool workstations to reduce a total setup cost of a manufacturing process whilst maintaining target delivery times. However, the methods and systems can equally be applied to reduce other machine tool workstation performance parameters in a manufacturing process, an entire supply chain, product development and logistics. In addition, the presently described techniques can be applied to other applications that are characterized as high mix low volume with different flow paths through multiple workstations. Furthermore, the presently described techniques can be applied to systems outside of manufacturing, e.g., systems and processes in product development, systems and processes in logistics, or any system or process that is effected by setup time.

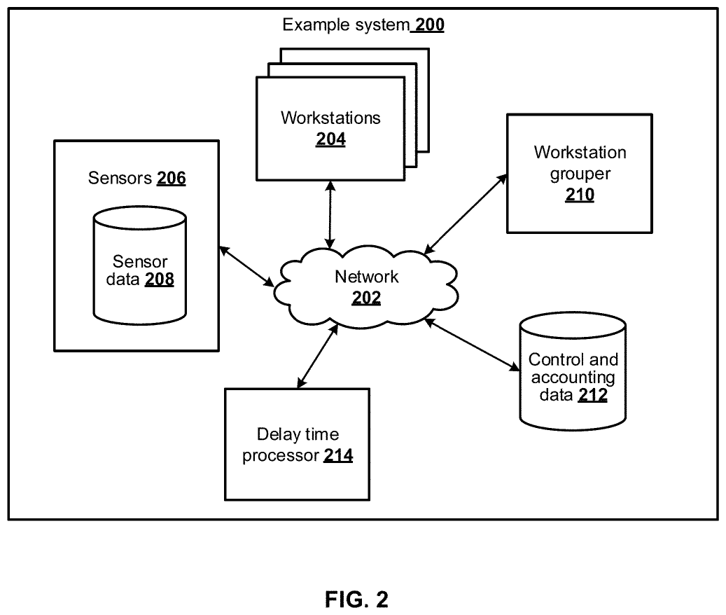

Example Systems for Controlling the Operation of Machine Tool Workstations FIG. 2 is a block diagram of an example system 200. The system 200 is an example of a system implemented as computer programs on one or more computers in one or more locations, in which the systems, components, and techniques described in this specification can be implemented.

In example system 200, a computer network 202, such as a local area network (LAN), wide area network (WAN), the Internet, or a combination thereof, connects, one or more workstations 204, one or more sensors 206, a sensor data store 208, workstation grouper module 210, control and accounting data store 212, and delay time processor 214. Although the example system 200 shows the workstations 204, sensors 206, sensor data store 208, workstation grouper module 210, data store 212, and delay time processor 214 as separately implemented components, in some implementations, some or all of the components can be implemented as a single computing system/integrated component. For example, the workstation grouper module 210, and delay time processor 214, and sensor data store 208 can be implemented as a single integrated component, whereas the data store 212 can be implemented on a centralized server that communicates and exchanges data with the system 200.

The one or more workstations 204 represent processing points in a system that transforms new work items into partially-completed or fully-completed work items. For example, the system can be a factory or job shop that manufactures work pieces, e.g., welded work pieces. In this example the one or more workstations 204 can be machine tool workstations, e.g., welding stations, and the new work items can be parts to be shaped or machined, e.g., welded, to partially or fully complete a work piece. In some implementations the one or more workstations 204 can further include other machines, devices or structures involved in a manufacturing process, e.g., paint booths. For convenience, the remaining description of FIG. 2 is described with reference to a factory that includes multiple machine tool workstations 204. The one or more machine tool workstations 204 can include drilling machines, turning machines, i.e., lathes, grinding machines, or boring machines. Other examples include milling machines, cutting tools, broaching machines, drill presses, gear shapers, hobbing machines, hones, screw machines, shears, shapers, saws, planers, stewart platform mills, or multitasking machines. Each machine tool workstation 204 is associated with multiple performance parameters that describe the performance of each machine tool workstation. The performance parameters can include one or more parameters relating to setup time, machine downtime, scrap percentage, processing time per unit, batch size, minimum work in progress (WIP) required to produce a fixed number of parts per hour, and a number of different part numbers.

For example 12 tool Okuma lathes can be used to process parts from stainless steel, Inconel, etc. When one of these lathes is about to finish a job, material and tooling for the next job in the schedule can be delivered to the lathe. Frequently, the diameter of the raw bar stock will be different, requiring a chuck change can take around an hour. In addition, all or most of the 12 tools in the turret may have to be changed and adjusted for stick-out length—taking another hour or more. In addition, trial parts may be run and checked by quality control, taking another hour. In all, the setup time from one part to another part could be around 4-6 hours.

Some or all of the performance parameters may be adjusted by making improvements to the machine tool workstations 204 or to the work process performed by the machine tool workstations 204. For example, the total machine tool workstation setup time for a particular process is dependent on how the collection of parts associated with the parts are released to the machine tool workstations 204. Therefore, improving the ordering of the release of the collection parts to the multiple machine tool workstations 204 can improve, e.g., reduce, the total setup time.

The one or more sensors 206 monitor the one or more machine tool workstations 204 and/or the process performed by the factory or job shop. For example, the one or more sensors 206 may be distributed throughout the factory or job shop. In some implementations the one or more sensors may include barcode scanners that scan parts as they pass through different points in the workstation. Each sensor can include an input module that imports measured data associated with the work process performed by the multiple machine tool workstations 204 or data associated with one or more of the machine tool workstations 204 involved in the work process. The input module may also receive additional data from a source external to the system 200, or may receive data from a source within the system 200. The input module may also access data, either from within the system 200 or from a source external to the system 200.

For example, the imported data may include one or more of: measured transit time information of items being processed by each machine tool workstation, measured transit time information for items flowing through the work process, e.g., a measured duration of time for each item to enter the process as new work and leave the process as completed work, WIP data such as a measured quantity of WIP in each workstation, a measure of all WIP in the process at a particular time, all measured WIP in the process over a defined time period, or a measured WIP for a particular part number, a particular type of workstation or a particular task within a transactional process. The WIP in any process may include more than one type of work unit or more than one type of task. In some implementations, the input module may reformat and/or transform the data such that the data may be processed and stored by other components within the system 200.

The one or more sensors 206 also include or are in data communication with the sensor data store 208. Data received through the input module can be stored in the sensor data store 208. The sensor data store 208 may be, for example, a relational database that logically organizes data into a series of database tables. Each database table may arrange data in a series of columns, e.g., where each column represents an attribute of the data stored in the database, and rows, e.g., where each row represents attribute values. The sensor data store 208 may be, for example, an object-oriented database that logically or physically organizes data into a series of objects. Each object may be associated with a series of attribute values. The sensor data store 208 may also be a type of database management system that is not necessarily a relational or object-oriented database. For example, a series of XML (Extensible Mark-up Language) files or documents may be used, where each XML, file or document includes attributes and attribute values. Data included in the sensor data store 208 may be identified by a unique identifier such that data related to a particular process may be retrieved from the sensor data store 208.

The production control data and accounting data store 212 can store production control data and accounting data. Production control data can include data related to the one or more machine tool workstations 204 involved in the work process. For example the production control data may include data describing the machine tool workstations, e.g., machine tool workstation type, age, make and model. The production control data may also include values for each machine tool workstation performance parameter for each machine tool workstation at a particular time or for a defined time period. The production control data may also include user-specified values for each machine tool workstation or the work process performed by the machine tool workstations, e.g., acceptable uninterrupted machine tool workstation runtimes. Accounting data can include data accessed by the sensors (e.g., from external databases) regarding costs and overheads associated with a work process, e.g., dollars of labor and supply chain overhead expended per month.

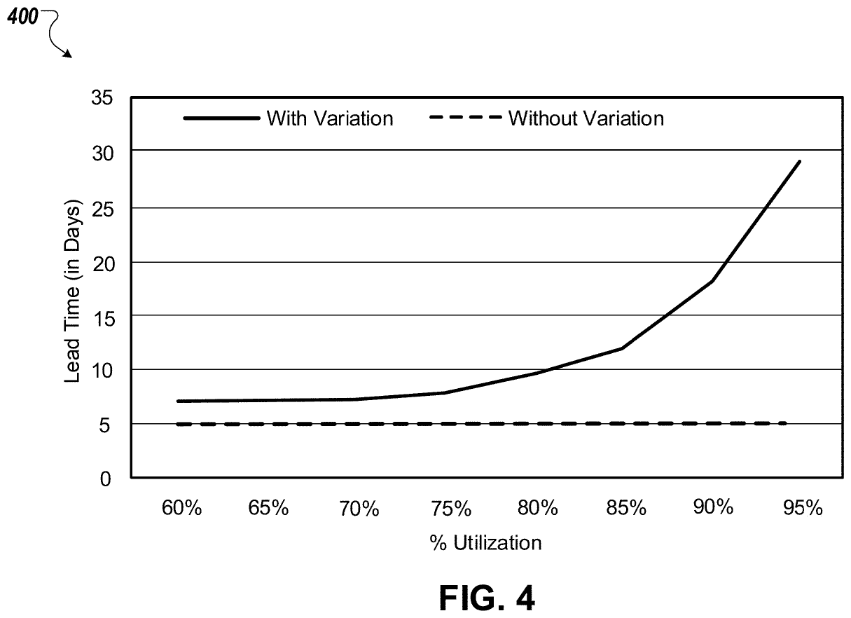

Although not shown in FIG. 2, in some implementations the system can include additional data stores that store the types of data described below with reference to FIGS. 4, 6, and 7.

The workstation grouper module 210 is configured to identify groupings of the machine tool workstations 204. To identify groupings of the machine tool workstations 204 the workstation grouper module 210 may access relevant sensor data stored in the sensor data store 208, e.g., production control data and measured sensor data.

Each group (also referred to herein as a “Pull System Group” or simply a “Pull Group”) can include workstations of the same type. For example, some or all drilling machines included in a factory may form one pull group, and some or all lathes included in a factory may form another pull group. As another example, workstations with a common Kanban inventory, e.g., workstations that share a common pool of jobs that are held in WIP, may form one pull group. In some implementations each pull group can be configured to receive a constrained fixed number of days of WIP per batch of parts, where the number of days depends on an average setup and machining time per part over each workstation in the pull group.

The number of multiple pull groups identified by the workstation grouper module 210 is dependent on, amongst other things, properties of the machine tool workstations 204. For example, in some cases the workstation grouper module 210 may group all cutting machines into one pull grouping. In other cases the workstation grouper module 210 may group all cutting machines into multiple pull groups of cutting machines that may be positioned near each other in the factory. Alternatively or in addition, the number of multiple pull groups may also be dependent on acceptable uninterrupted machine tool workstation runtimes. For example, boring machines that must be serviced after a predetermined amount of uninterrupted runtime may be grouped into a same pull group.

In some implementations the workstation grouper module 210 is further configured to implement identified pull groupings of machine tool workstations, e.g., electronically or physically.

The workstation grouper module 210 may be a specialized hardware or software module that is pre-programmed or pre-configured to invoke a specialized or proprietary grouping functionality only. In another aspect, the workstation grouper module 210 may be a more generic hardware or software module that is capable of implementing generic and specialized functionality, including grouping functionality.

The delay time processor 214 is configured to access data stored in the sensor data store 208 and other data stores, e.g., data store 212. The delay time processor 214 processes the accessed data to compute average delay times at Pull groups or at machine tool workstations in the Pull groups using Little's Law. Little's law states:

$$Delay time at step i = \frac{Number of jobs in WIP at step i}{Exit rate of jobs per hour at step i} . \qquad ( 1 )$$

The delay time processor 214 is further configured to access other data, e.g., production control and accounting data or other types of data described in this disclosure and use this data and computed delay times to compute lead times for each jobs being performed by the workstations 204, as described below with reference to FIGS. 4, 6, and 7. In some implementations the delay time processor 214 can also be configured to compute other quantities such as a delay time standard deviation or a Pollaczek-Khintchine equation in order to compute the delay times or lead times, as described below with reference to FIGS. 4, 6, and 7.

The delay time processor 214 can also be configured to compare computed lead times to target completion times to determine whether one or more jobs are running behind schedule. In response to determining that one or more jobs or tasks are running behind schedule or will not meet respective target completion times, the delay time processor 214 can adjust the order at which one or more of the Pull groups process jobs to reduce the number of jobs that are running behind schedule and/or reduce the amount of time at which jobs are running behind schedule, e.g., by transmitting instructions to the workstations 204 indicting the new processing order.

The delay time processor 214 may be a specialized hardware or software module that is pre-programmed or pre-configured to invoke a specialized or proprietary functionality only. In another aspect, the delay time processor 214 may be a more generic hardware or software module that is capable of implementing generic and specialized functionality, including computing average delay times.

### Example Method for Processing Parts Using Multiple Machine Tool Workstations.

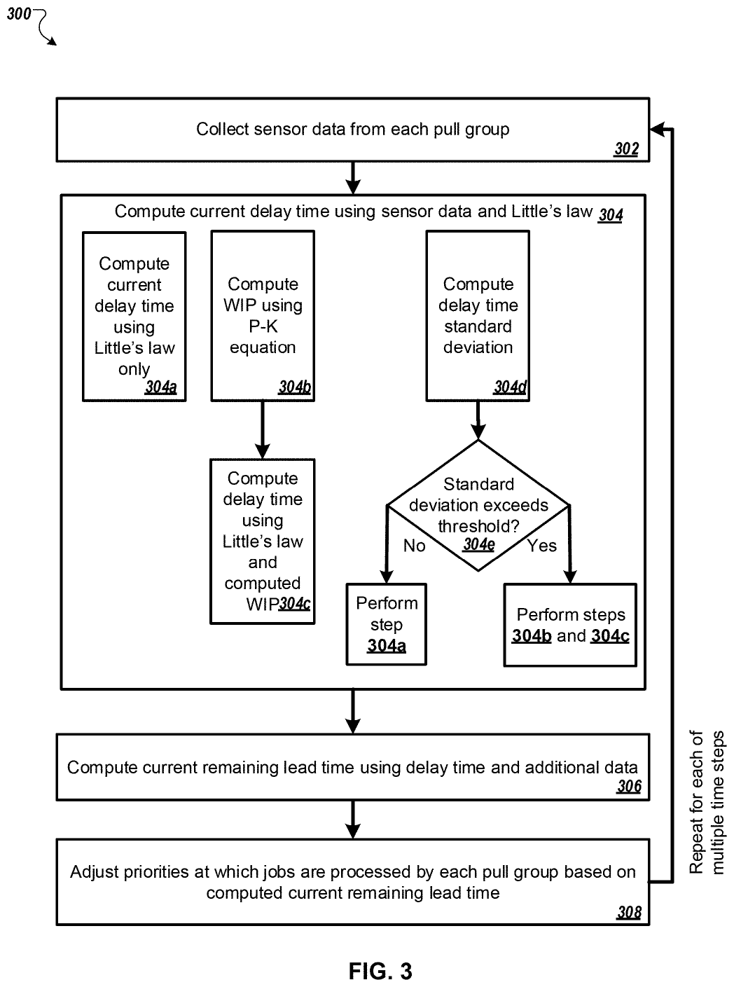

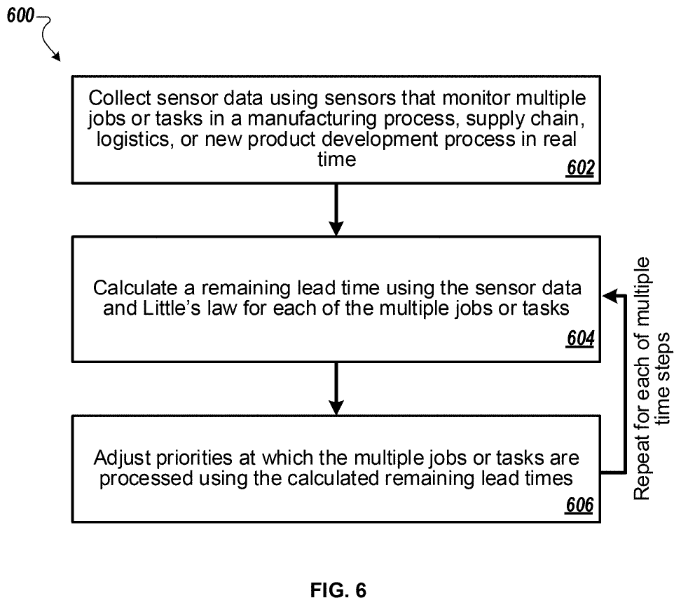

FIG. 3 presents an example process 300 for processing parts using multiple machine tool workstations. For convenience, the process 300 will be described as being performed by a system of one or more computers located in one or more locations. For example, the process 300 can be performed by system 200 described with reference to FIG. 2 above. In addition, the process 300 will primarily be described with reference to processing parts using machine tool workstations located in one job shop or factory. However, example process 300 can also be used to process parts using machine tool workstations that are located in different job shops or factories, e.g., as part of a supply chain, as described below with reference to FIG. 6.

A factory includes multiple machine tool workstations producing different part numbers. Each part number can progress through the factory using a different path of machine tool workstations. Different part numbers processed by a same machine tool workstation can require a different setup of the machine tool workstation. Changing the setting of a machine tool workstation can take a considerable amount of time, e.g., several hours. This time causes delays in the production process and increases the factory's costs.

The machine tool workstations are grouped into multiple Pull groups. Each Pull group includes workstations of the same type. For example, some or all drilling machines included in the factory can form one Pull group, and some or all lathes included in the factory can form another Pull group. The number of multiple Pull groups is dependent on, amongst other things, properties of the plurality of machine tool workstations. For example, in some cases all cutting machines can be grouped into one Pull grouping. However, in other cases all cutting machines can be grouped into multiple Pull groups of cutting machines that can be positioned near each other in the factory. The number of multiple Pull groups can also be dependent on acceptable uninterrupted machine tool workstation runtimes. For example, boring machines that must be serviced after a predetermined amount of uninterrupted runtime can be grouped into a same Pull group.

Each Pull group can be configured to receive a constrained number of days of work in progress per batch of parts, wherein the number of days depends on an average setup and machining time per part over each workstation in the Pull group. The establishment of caps on number of jobs in process at each step controls process lead time, and can continuously improve the responsiveness and flexibility of the process (which can be impossible without WIP caps.)

A quantity of a specific part number (referred to herein as a job) flows through the factory on a respective router path consisting of many steps, where at each step the job is processed by a respective Pull group. At any given time, the factory can process multiple jobs. Therefore, jobs compete for time at machine tool workstations in a Pull group and queues occur at the Pull groups. This creates a need for an order at which jobs are to be processed in each Pull group, i.e., a sequence at which jobs are processed in each Pull group. The orders should ensure that jobs are completed on time, e.g., as specified by a customer. In addition, the orders should depend on various factors including machine tool workstation setup times and dynamically changing conditions in the factory such as unexpected difficulties experienced by one or more of the machine tool workstations, quality problems with parts processed by one or more machine tool workstations, or changes in the performance of one or more machine tool workstations, e.g., some machine tool workstations can achieve an above average performance under certain conditions.

To create orders at each pull group, the system collects data from pull groups in the factory at each of multiple time steps until a predetermined condition is satisfied (step 302). For example, the system can repeatedly collect data at regular predetermined time intervals, e.g., time intervals with a same duration such as 15 minutes, or can repeatedly collect data when processing stages are completed, e.g., each time a pull group finishes processing a job. In some implementations the predetermined condition can be satisfied when the factory or each pull group have processed all required jobs.

The data collected by the system can include sensor data, e.g., IoT sensor data, obtained from local processors and sensors that monitor the machine tool workstations and/or jobs processed by the factory. The sensor data can include data representing a number of jobs currently being processed by or queued at each pull group and data representing a current rate of the number of jobs exiting each pull group.

In some implementations the time intervals can be the same for each pull group. That is, at each time step the system can collect data from each pull group. In these implementations the time intervals can be determined in advance based on the type of jobs being performed by the factory, e.g., based on an average machining time per part for the factory. In some implementations data collected from pull groups that perform jobs with shorter average machining times is likely to be more dynamic and susceptible to changes, e.g., compared to data collected from pull groups that perform jobs with longer average machining times. Therefore, selecting the time intervals based on factors such as average machining time can improve the computational efficiency of example process 300, since repeat collection of static data can be avoided. In other implementations the time intervals can vary for each pull group, e.g., the system can collect data from some pull groups more often than others. For example, the system can collect data from a pull group with a shorter average machining time more frequently than from a pull group with a longer average machining time.

In either of the implementations described above, the time intervals (i.e., frequency of the time steps) can also be determined in advance based on the computational capabilities of the system performing example process 300, e.g., data can be collected more frequently if the system has more computational capabilities. Alternatively or in addition, the time intervals can be determined in advance based on a target accuracy of the delay times and associated quantities computed by the system at step 304 described below. As discussed in more detail below, the accuracy of delay times and quantities computed using the determined delay times, e.g., estimated completion times, increases with the number of time steps. Therefore, the number of time steps can be chosen in advance such that computed delay times are likely to meet a target accuracy. This can ensure that adjustments made to priorities at which jobs are processed by each pull group (as described below with reference to step 306) are effective and therefore improves the likelihood that final products meet target delivery times.

In some implementations the local processors and sensors that monitor the machine tool workstations and/or jobs processed by the factory can be configured to trigger the system to collect data. For example, the local processors and sensors can be configured to notify the system when an unexpected event occurs or an unexpected operational status is detected, e.g., if a machine tool workstation stops working due to a fault, if a machine tool workstation is unexpectedly idle, or if a machine tool workstation setup is unexpectedly changed. The unexpected events/operational statuses and rules for determining when to send a trigger signal to the system are factory/process specific and can be determined in advance.

In response to receiving a trigger signal from a local processor or sensor, the system can perform steps 302-306 in order to recover from the unexpected event. For example, if a machine tool workstation is monitored in real time and a trigger signal is sent to the system in response to determining that the machine tool workstation has stopped working, adjustments to the processing schedule can be made without delay since the system would not wait for the next time step to perform data collection and determine appropriate adjustments.

The data collected by the system can also include production control data and accounting data. Production control data can include data related to the one or more machine tool workstations 204 involved in the work process. For example the production control data can include data describing the machine tool workstations, e.g., machine tool workstation type, age, make and model. The production control data can also include values for each machine tool workstation performance parameter for each machine tool workstation at a particular time or for a defined time period. The production control data can also include user-specified values for each machine tool workstation or the work process performed by the machine tool workstations, e.g., acceptable uninterrupted machine tool workstation runtimes. The production control data can also include data specifying estimated processing times for jobs. Accounting data can include data regarding costs and overheads associated with a work process, e.g., dollars of labor and supply chain overhead expended per month. The production control data and accounting data can be collected at less regular time intervals compared to the sensor data, e.g., hourly, daily, or weekly.

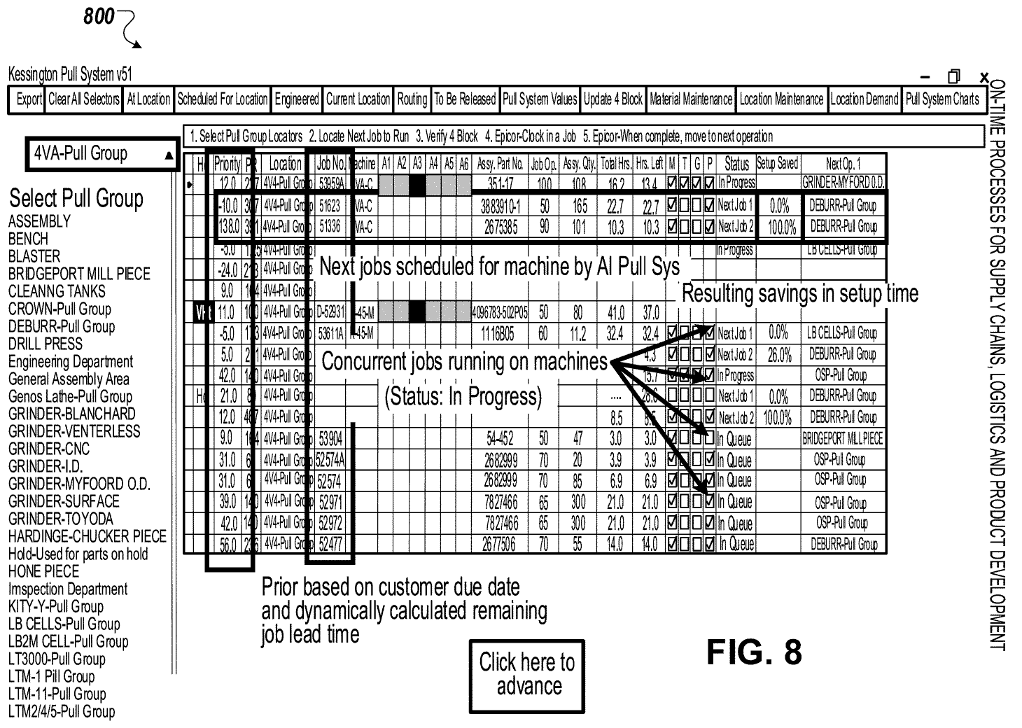

In some implementations the system can convert collected data to a common format to enable the system to process the data and perform calculations using the data, as described below with reference to steps 304 and 306. Converting the collected to a common format can also enable users of the system to analyze and interact with the data, as described below with reference to FIG. 8.

The system processes some or all of the collected data for the time step to determine a current average delay time at each Pull group (or at each machine tool workstation in each Pull group) using Little's Law (step 304). Little's law states:

$$Delay time at step i = \frac{Number of jobs in WIP at step i}{Exit rate of jobs per hour at step i} . \qquad ( 2 )$$

In some implementations Equation (2) can also be applied to calculate a delay time that is based on other metrics of interest, e.g., depending on the specific application of the method and the type of data collected by the sensors. For example, Equation (2) can calculate a delay time that is based on a number of pieces at step i or a number of hours at step i.

Because an average delay time for a particular step is susceptible to random fluctuations at downstream steps, e.g., due to unexpected difficulties, above average performance or quality problems, the delay time in Equation (2) is a random variable. It could be expected that the overall standard deviation of the delay time is the sum of the standard deviation at each step. However, the overall standard deviation is this sum divided by the square root of N, which reduces the need for re-prioritization corrections to increase on time delivery. The cumulative random fluctuations measured by N standard deviations a declines over N steps per:

$$cumulative standard deviation ( σ ) in N steps = \frac{( {\sum }_{i = 1}^{N} {σ}_{i} )}{\sqrt{N}} \qquad ( 3 )$$

The formula above is exact if all steps in the process have the same standard deviation of delay time. However, Monte Carlo simulations show that it is ˜90% accurate so long as the average total delay time of standard deviation is maintained.

In some implementations the system can perform additional or alternative processing steps in example process 300 to improve the accuracy of the delay times computed at step 304. For example, in manufacturing processes the standard deviation of completing a given task can vary due to several factors, e.g., unexpected difficulties that reduce workstation performance, delays in arrivals of parts that require processing, or faults that produce defective parts that need to be reworked. Such factors can result in an increase in the actual number of work or tasks in progress, which in turn affects the accuracy of the computation of Little's law and subsequently computed delay times. The effects of these factors increases in other settings, e.g., systems outside of manufacturing such as systems and processes in product development or systems and processes in logistics. For example, the standard deviation of completing a given task compared to an expected average in a new product development setting is typically much larger than in the setting of completing a product at a given Pull station step in a supply chain. As another example, the probability of rework of a new product development task is also typically much greater than in the Supply Chain.

To account for these effects, the system can use the Pollaczek-Khintchine equation to compute a more accurate number of jobs in WIP. The Pollaczek-Khintchine equation typically describes the relationship between the queue length and service time distribution Laplace transforms for an M/G/1 queue, where jobs arrive according to a Poisson process and have general service time distribution. The equation also describes the relationship between the mean queue length and mean waiting/service time in this model. For the settings described in this disclosure, the Pollaczek-Khintchine equation is used to describe the relationship between a current number of tasks in process, e.g., at a respective pull group, and variables that include utilization percentage, the number of cross trained resources, rework percentage, the variation of time to perform tasks and the variation of the arrival of tasks. For example, the Pollaczek-Khintchine equation can be given by:

$$WIP = no . of tasks in process = ( \frac{1}{K + 1} ) ( \frac{{ρ}^{2} {\{ 1 + Z \}}^{2}}{1 - ρ \{ 1 + Z \}} ) ( \frac{{C}_{s}^{2} + {C}_{A}^{2}}{2} ) \qquad ( 4 )$$

where ρ represents the percentage of maximum capacity utilized, K represents the number of cross-trained resources needed by the pull group, Z represents the percentage of defectives that must be reworked, C_{S} represents the variation of time to perform tasks, and C_{A} represents the variation of the arrival of tasks, with C_{A}=σ_{A}/μ_{A} and C_{S}=σ_{S}/μₛ where σ_{A}, σ_{S} and μ_{A}, μ_{S} represent the standard deviation of the arrival of tasks or time to perform tasks and the mean arrival of tasks or time to perform tasks, respectively. All of these quantities are derivable from or directly included in the sensor data. As shown in Equation (4), higher variations Cₛ² and C_{A}² can dramatically increase the number of tasks in process/queued and hence delay time (since an increase in the number of tasks in process increases the numerator of Littles law).

The impact of the Pollaczek-Khintchine equation given by Equation (4) on task time can be seen in FIG. 4. FIG. 4 shows a graph 400. The x-axis of the graph 400 represents utilization (measured as a percentage) and the y-axis of the graph 400 represents lead time (in days). The dotted line shows lead time as a function of utilization without variations in the time to perform the task. In this example, the delay time is approximately 5 days with no variation in the task. The solid line shows lead time as a function of utilization with variations in the time to perform the task. As shown, lead time increases as utilization increases.

This increase shows that staffing a task at more than 80% of capacity will double the delay time. To avoid this problem, the system can calculate p, K, and the % of the engineers and programmers capacity at each step of the process which is necessary to attain management's schedule for completing the manufacturing process or new product development on-time. Experience shows that engineers and programmers should never be scheduled more than p=80% and frequently must be scheduled at p=40%. However, the presently described techniques can be used to calculate a maximum number of tasks at each step which will attain a target delivery date. The presently described techniques thus enable proper staffing of a project at the front end.

By contrast, typical new manufacturing processes or product development planning attempts to determine how many man-months of processing or development time is required, and calculates the number of engineers needed. The project is often staffed using 100% of engineers capacity. The failure of this method has been described as “adding manpower to a late software project just makes it later.” That is, adding new engineers who need mentoring simply boggs down the experienced engineers and “just makes it later”. The use of the Pollaczek-Khintchine equation enables man-power to be loaded up-front, keeping the process on schedule from the beginning, and limiting late-term additions to the unforeseen requirements, thus minimizing the disruption of additional engineers.

Returning to FIG. 3, the system can compute the delay time at step 304 in various ways. For example, the system can process some or all of the data collected at step 302 to determine a current average delay time at each Pull group (or at each machine tool workstation in each Pull group) directly using Little's Law (step 304a).

Alternatively, the system can process the sensor data and other data, e.g., production control data, accounting data, and/or historical data, to compute the WIP as per Equation (4) above (step 304b). The system can then use Little's law and the WIP computed using Equation (4) to determine a current average delay time at each Pull group (step 304c).

Alternatively, the system can compute a standard deviation of the delay time (step 304d). The system can determine whether the computed standard deviation is larger than a predetermined acceptable threshold (step 304e). The threshold can be selected in advance based on a system-specific target accuracy. In response to determining that the computed standard deviation is not larger than the predetermined acceptable threshold, the system can compute the delay time directly using Little's law (step 304a). In response to determining that the computed standard deviation is larger than the predetermined acceptable threshold, the system can compute the delay time by computing the WIP as per Equation (4) above and then using Little's law and the WIP computed using Equation (4) (steps 304b and 304c). Incorporating the Pollaczek-Khintchine equation only in situations where the standard deviation of the delay time exceeds a predetermined acceptable threshold can improve the processing efficiency of example process 300, since unnecessary additional computations and retrieval of data are avoided.

The system uses the determined current average delay time at each Pull group (or at each machine tool workstation in each Pull group) to compute a lead time for each active job (step 306). The system can also use additional data to compute the lead time for each active job, e.g., production control data and accounting data. For example, for a particular job the current average delay times at each Pull group that the job passes through can be added (and combined with an estimated processing time for the particular job, e.g., as specified as by the production control data) to predict a lead time for the particular job.

As another example, in implementations where finished jobs are to be shipped to a customer or to another factory, e.g., as part of a supply chain, the system can also use transport data to compute the lead time for each active job, e.g., data indicating current traffic conditions, current weather conditions, data indicating which transport services have availability, data indicating a historical reliability of transport services (such as whether the transport service takes direct routes to a target location or deviates and makes several stops along the way). For example, for a particular job the current average delay times at each Pull group that the job passes through can be added and combined with an estimated transport time, e.g., as specified as by a route planner that takes into account current traffic and weather conditions, to predict a lead time for the particular job. Generally, in implementations where the processing of parts includes several steps or stages (within a same factory/location or spread out over multiple factories/locations), the current average delay times at each step or stage can be combined to predict a corresponding lead time.

The system then compares the estimated lead times to target completion times, e.g., which are based on customer demand, to determine whether one or more jobs are running behind schedule. In response to determining that one or more jobs or tasks are running behind schedule or will not meet respective target completion times, the system adjusts the order at which one or more of the Pull groups process jobs to reduce the number of jobs that are running behind schedule and/or reduce the amount of time at which jobs are running behind schedule (step 308).

For example, if a job is currently being processed by a Pull group corresponding to step i and its estimated lead time indicates that an estimated completion time is later than its target completion time, the job can receive a higher priority at the next Pull group corresponding to step i+1. The adjustments, e.g., changes to the job's priority at a next Pull group, can depend on various factors including the severity of the current delay, a penalty associated with delayed completion (e.g., contractual obligations with a customer), and/or customer fulfillment history. The adjustments can occur each time data is collected from the factory at step 302, e.g., every 15 minutes or in response to receiving a trigger signal. To adjust the order at which one or more of the Pull groups process jobs the system can transmit data representing the adjusted orders to the machine tool workstations or operators such that parts can be released for processing in each Pull group according to the adjusted orders. In supply chain or logistics settings, adjusting the order at which jobs or tasks are processed can include repositioning a transportation vehicle. For example, the system can send instructions specifying a new transportation route to be taken, e.g., by transmitting a new route to a navigation system included in a transportation vehicle or by directly programming a self-driving car to follow a new route. As another example the system can send instructions specifying a new transportation schedule that adjusts the current order of scheduled stops, e.g., by transmitting a new schedule to a navigation system included in a transportation vehicle or by directly programming a self-driving car to follow a new schedule.

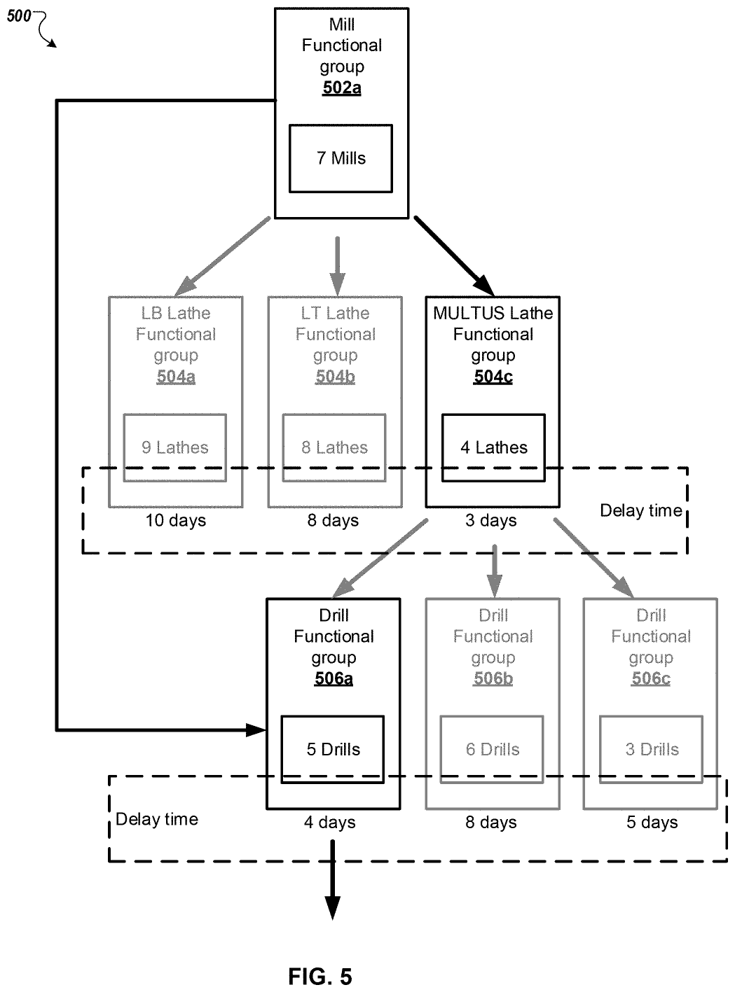

FIG. 5 is a block diagram 500 of example pull groups and example paths of parts generated based on dynamically calculated lead times, as described above with reference to example process 300 of FIG. 300.

The example pull groups shown in FIG. 5 include one mill pull group 502a, three lathe pull groups 504a-c, and three drill pull groups 506a-c. Each pull group includes multiple machine tool workstations. For example, mill pull group 502 includes 7 drills, lathe pull group 504a includes 9 lathes, etc. The number, type and size of pull groups shown in FIG. 5 are illustrative only—the number, type and size of pull groups can vary based on the particular factory/collection of machine tool workstations.

Conventionally, systems can process parts according to a path of machine tool workstations that is determined and fixed in advance. For example, if a particular part is to be machined by a mill and then a lathe, the fixed path can route such parts from a particular mill in the factory, e.g., a mill in pull group 502a, to a particular lathe, e.g., a lathe in pull group 504a, based on some factors or properties that can be determined in advance, e.g., location of the machines or machine operator. However, in the example shown in FIG. 5, routing parts from a mill in pull group 502a to a lathe in pull group 504a can delay output by an average of 10 days (as calculated by Little's Law or both Little's Law and the P-K equation).

Instead, by following example process 300, systems can process parts according to a path of machine tool workstations that is dynamically determined and adjusted, such that the total processing of parts can achieve a reduced or even optimal delay time. For example, FIG. 5 shows how, at a current time, a lowest delay time can be achieved by routing a subset of milled parts that need metal removing operations from the mill pull group 502a to the 4 Multus lathes included in lathe pull group 504c, and a subset of parts that need drilling from the mill pull group 502a to the 5 drills included in pull group 506a.

### Example Method for Processing Jobs or Tasks in a Manufacturing Process, Supply Chain, Logistics, or New Product Development Process

FIG. 6 presents an example process 600 for processing multiple jobs or tasks. For convenience, the process 600 will be described as being performed by a system of one or more computers located in one or more locations. For example, the process 600 can be performed by the delay time processor described with reference to FIG. 2 above. Further, example process 600 can be performed in conjunction with and/or using some or all of the techniques described above with reference to example process 300 of FIG. 3.

The system collects sensor data from the multiple jobs or tasks using sensors that monitor the multiple jobs or tasks in real time (step 602).

At each of multiple time steps and for one or more of the multiple jobs or tasks, the system repeatedly calculates a remaining lead time using Little's Law and the collected sensor data (step 604) and uses the calculated remaining lead times to adjust priorities at which the multiple jobs or tasks are processed (step 606).

In some implementations example process 600 can be applied to a manufacturing process and used to process parts using multiple machine tool workstations, as described above with reference to example process 300 of FIG. 3.

In other implementations example process 600 can be applied to a supply chain and used to process parts using various workstations, services, and logistics in different locations. In these implementations the sensor data can include the sensor data described above with reference to step 302 of FIG. 3, e.g., from each factory that refines, manufactures or assembles required supply chain parts. The sensor data can be obtained from a barcode on a traveler of a job, e.g., using Internet of Things devices such as handheld barcode readers that are connected to the internet and the presently described software. Such handheld scanners can detect or allow an operator to input the loss due to scrap and rework. The sensor data can also include other types of sensor data, e.g., relating to the sourcing or raw materials and transportation between factories. For example, in some implementations the sensor data can include data indicating when required raw materials have been sourced or extracted. Alternatively or in addition, the sensor data can include data received from sensors that monitor workstations that assemble basic parts into part-finished or finished products. Alternatively or in addition, the sensor data can include data indicating current traffic conditions, weather conditions, transportation timetables and availability, expected arrival times, or other data related to transporting parts between factories, workstations, or customers. Alternatively or in addition, the sensor data can track stock and/or inventory and include data indicating a currently amount of stock and/or inventory. In some implementations the sensor data can include job number, part number, quantity to be produced, scrap loss, due date, and special instructions. Some or all of this data can be used to calculate a remaining lead time of jobs in the supply chain, e.g., using equations (2)-(4) described above with reference to steps 304 and 306 of FIG. 3.

In other implementations example process 600 can be applied to a new product development process and used to process parts using various workstations, services, and logistics to bring a new product to market or renew an existing product. In these implementations the sensor data can include similar sensor data to that described above in relation to processing parts in a supply chain. In some implementations the sensor data can include data specific to product development such as target times to complete steps of the process, input required from other engineers, material or software needed to complete the step, progress entered by computer or hand held bar code readers, and status versus completion date. Some or all of this data can be used to calculate a remaining lead time of jobs in the new product development process, e.g., using equations (2)-(4) described above with reference to steps 304 and 306 of FIG. 3.

In the above described supply chain setting and new product development setting, the sensor data can be collected at the end of each stage of the supply chain, e.g., when raw materials have been transported to the first factory for processing, after each factory finishes processing parts, after each factory finishes assembling parts, or after parts have been transported from one factory to another. Alternatively or in addition, the sensor data can be collected when individual workstations within a factory have finished processing or assembling a part. Alternatively or in addition, the sensor data can be collected regularly at predetermined intervals of time, e.g., every 15 minutes. Alternatively or in addition, the sensor data can be collected in response to a trigger signal, as described above with reference to FIG. 3. For example, local processors and sensors monitoring the process can be configured to notify the system when an unexpected event occurs or an unexpected operational status is detected, e.g., if traffic conditions change and a traffic jam is causing a delay in transport time, if a transportation vehicle breaks down, or if weather conditions change and transportation services are cancelled or redirected on another route that takes a longer time.

In other implementations example process 600 can be applied to logistics and used to organize the movement or transport of people or goods from one location to another. In these implementations the sensor data can include data indicating when materials, parts, or people at respective locations are queueing to be processed or are ready for collection. Alternatively or in addition, the sensor data can include data indicating current traffic conditions, weather conditions, transportation timetables and availability, expected arrival times, or other data related to transporting materials, parts, or people between various locations. Some or all of this data can be used to calculate a remaining lead time until the people or goods reach an end destination, e.g., using equations (2)-(4) described above with reference to steps 304 and 306 of FIG. 3.

In the above described logistics setting, the sensor data can be collected at the end of each stage of the logistics operation, e.g., when a vehicle, train, airplane, or ship arrives at a particular location. Alternatively or in addition, the sensor data can be collected regularly at predetermined intervals of time, e.g., every 15 minutes. Alternatively or in addition, the sensor data can be collected in response to a trigger signal, as described above with reference to FIG. 3. For example, local processors and sensors monitoring the process can be configured to notify the system when an unexpected event occurs or an unexpected operational status is detected, e.g., if traffic conditions change and a traffic jam is causing a delay in transport time, if a transportation vehicle breaks down, or if weather conditions change and transportation services are cancelled or redirected on another route that takes a longer time.

The majority of supply chains, new product development, and logistics processes suffer from an inability to deliver desired output to meet a time predetermined by customer schedule 50% of the time due to deficiencies in their Enterprise Resource Planning (ERP) software. ERP scheduling uses human guesses/estimates for static queue times at each step in the process which have been entered as a static input into the ERP system. By contrast, the presently described techniques can use the Internet of Things to dynamically report the actual units in queue at each step of the process, as well as the actual exit rate from that step in units per unit time. The systems and methods utilize Little's law, which gives the ratio of units in queue/exit rate, and equals the actual queue delay time at a step in the process. By adding up the queue times at each step in the router of the process, the actual time to completion can be predicted and corrected to 98% on time delivery. If the presently described techniques detect that a certain output Job may be late to a target schedule, the job will be re-prioritized at downstream process steps to achieve the target completion date. In some implementations, to ensure that 98% on-time delivery is maintained, the presently described techniques can also assign a maximum amount WIP at each step of the process.

### Example Method for Processing Jobs and Tasks in a Supply Chain

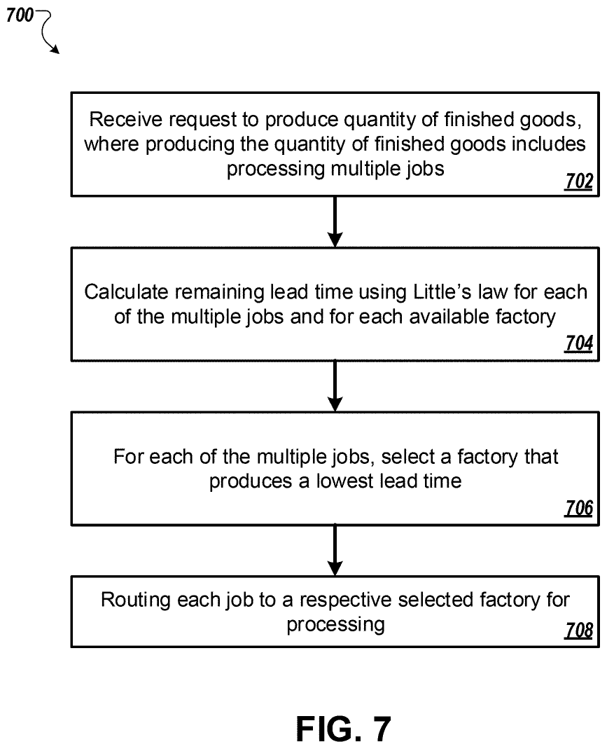

FIG. 7 presents an example process 700 for processing multiple jobs or tasks in a supply chain. For convenience, the process 700 will be described as being performed by a system of one or more computers located in one or more locations. For example, the process 700 can be performed by a delay time processor as described with reference to FIG. 2 above. Further, example process 700 can be performed in conjunction with and/or using some or all of the techniques described above with reference to example process 300 of FIG. 3 and/or example process 600 of FIG. 6.

The system receives a request to produce a quantity of finished goods, where producing the quantity of finished goods comprises processing multiple jobs (step 702). The system calculates, for each job of the multiple jobs and for each of multiple available factories, a remaining lead time using Little's law (step 704). The system selects, based on the calculated remaining lead times and for each job of the multiple jobs, a factory that results in a lowest lead time (step 706). The system routes each job of the multiple jobs to a respective selected factory for processing (step 708).

The heart of supply chains are factories which receive input materials and services from a supply chain input and supply finished goods to downstream supply chain warehouses, logistics distribution, and on to customers who want products delivered on-time according to their schedules. Some supply chains can have hundreds of factories. When an order is received from a customer, it is likely that the order can be produced by more than one of these factories.

In example process 700, before a job is released, the system calculates its lead time in each of the factories and selects a factory with a lowest lead time to route the job to. If the system determines that multiple factories have a same lead time, the system can determine to route the job to a factory that has i) the lowest shipping cost to the customer through distribution and warehousing and ii) in the case of a tie in lowest shipping costs, the factory with the most spare production capacity. Implementing this routing of jobs can result in on-time performance at a lowest cost while maximizing factory utilization and minimizing overall cost.

Since individual factories can receive jobs or tasks from various sources, the individual factories can also locally implement the presently described techniques to process the jobs or tasks it is receiving from different customers using its workstations to also improve the local performance of the factory. That is, the presently described techniques can be applied locally and globally in the supply chain.

### Example GUIS to Enable User-Machine Interactions

In some implementations the system can provide a GUI that displays information relating to the processing of jobs or parts during any of the above described processes 300, 600, or 700. FIG. 8 shows an example GUI 800. The GUI 800 enables a user to view the status of the process, e.g., the jobs being processed, machines or services that are processing the jobs, location of the jobs being processed, part numbers associated with the jobs, a job quantity, a total number of hours required by each job, a current number of hours left for each job, the status of each job (e.g., in progress or in queue), the saved setup time (resulting from application of the presently described techniques), the job's current priority (a value that can dynamically change using the presently described techniques. Such data can be displayed in response to a user selecting one or more filters. For example, the GUI can enable a user to select subsets of data to display, e.g., according to location, status, type, pull groups, etc.

In some implementations the GUI 800 can allow a user to manually trigger steps of example processes 300, 600, and 700. For example, the GUI 800 can include a functional means that enables a user to cause the system to collect sensor data and process the sensor data to adjust priorities at which jobs or tasks are processed. If the project appears to be behind schedule, management will be alerted and a corrective action plan can be developed. Late Product Development is generally the result of understaffing the initial launch of the project and provides a learning cycle for management.

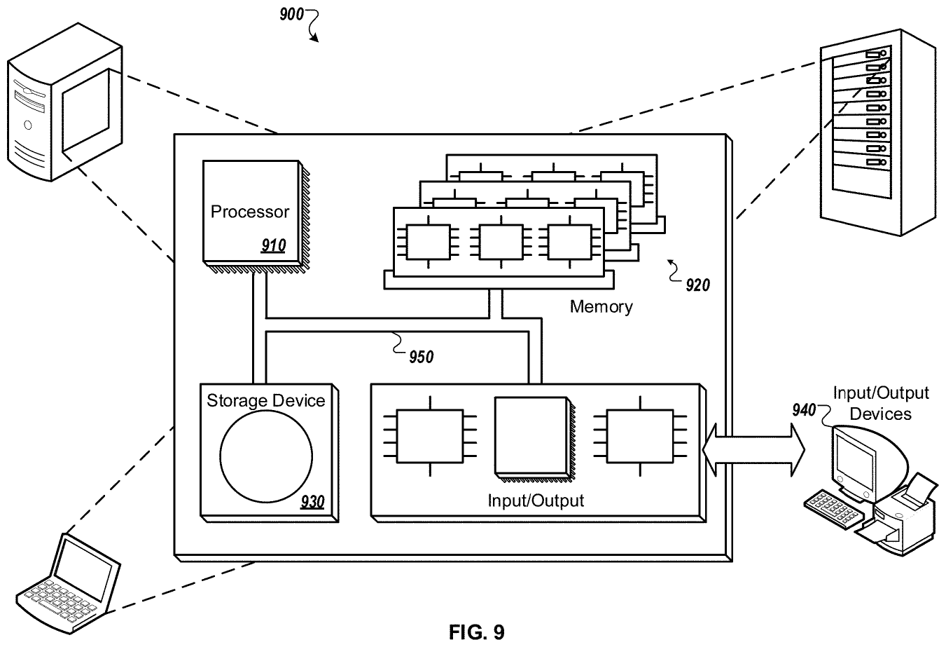

FIG. 9 is a schematic diagram of a generic computer system 900. The system 900 can be used for the operations described in association with any of the computer-implement methods described previously, according to one implementation. The system 900 includes a processor 910, a memory 920, a storage device 930, and an input/output device 940. Each of the components 910, 920, 930, and 940 are interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 may be a floppy disk device, a hard disk device, an optical disk device, or a tape device.

The input/output device 940 provides input/output operations for the system 900. In one implementation, the input/output device 940 includes a keyboard and/or pointing device. In another implementation, the input/output device 940 includes a display unit for displaying graphical user interfaces.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
processing multiple jobs using a plurality of workstations, wherein the plurality of workstations are grouped into multiple Pull groups, each Pull group comprising one or more workstations of a same type, the processing comprising, repeatedly, at each of multiple time steps until a predetermined condition is satisfied:
collecting, using sensors that monitor the plurality of workstations, sensor data from Pull groups in the multiple Pull groups;
computing, for each of the multiple jobs, a current remaining lead time using the collected sensor data and Little's Law; and
adjusting, based on the computed current remaining lead times, priorities at which the multiple jobs are processed by each Pull group.

2. The method of claim 1, wherein the multiple time steps correspond to predetermined time intervals, wherein the predetermined time intervals comprise a same duration, optionally wherein the same duration is determined based on an average machining time per job for the plurality of workstations.

3. The method of claim 1, wherein at each of the multiple time steps, sensor data is collected from each Pull group or from a subset of the multiple pull groups.

4. The method of claim 1, wherein the multiple time steps correspond to times at which stages of the processing of the multiple jobs are completed.

5. The method of claim 1, the multiple time steps correspond to predetermined time intervals, wherein the predetermined time intervals vary for each of the multiple pull groups, optionally wherein a time interval corresponding to a respective pull group is determined based on an average machine time per job for the pull group.

6. The method of claim 1, wherein a frequency of the multiple time steps is based on one or more of a target accuracy of the remaining lead times and system computational capability.

7. The method of claim 1, further comprising:
receiving, at one or more of the multiple time steps, a trigger signal from one or more sensors that monitor respective workstations in real time, wherein the trigger signal is sent by the one or more sensors in response to the one or more sensors detecting an unexpected event or operational status; and
in response to receiving the trigger signal, collecting sensor data from pull groups that include respective workstations, computing a current remaining lead time using the collected sensor data and Little's Law, and adjusting priorities at which the multiple jobs are processed by each Pull group.

8. The method of claim 1, further comprising one or more of:
obtaining production control data and accounting data and computing, for each of the multiple jobs, a current remaining lead time using the obtained production control data and accounting data; or
obtaining transport data, the transport data comprising data indicating current traffic conditions, data indicating current weather conditions, data indicating available transport services, or data indicating a historical reliability of transport services, and computing, for each of the multiple jobs, a current remaining lead time using the obtained transport data.

9. The method of claim 1, wherein the predetermined condition is satisfied when each of the multiple jobs has been completed.

10. The method of claim 1, wherein computing a current remaining lead time for a job using the collected sensor data and Little's Law comprises:
determining, using the sensor data and Little's Law, a current average delay time at each Pull group; and
estimating, using the current average delay time at each Pull group, a lead time for the job.

11. The method of claim 10, wherein determining, using the sensor data and Little's Law, a current average delay time at each Pull group comprises:
computing a number of jobs in WIP using the sensor data and determining the current average delay time at each Pull group using Little's law and the computed number of jobs in WIP; or
computing a number of jobs in WIP using a Pollaczek-Khintchine equation and determining the current average delay time at each Pull group using Little's law and the computed number of jobs in WIP.

12. The method of claim 11, wherein the Pollaczek-Khintchine equation relates a current number of jobs in process with variables comprising utilization percentage, a number of cross trained resources, rework percentage, a variation of time to perform jobs and a variation of the arrival of jobs.

13. The method of claim 10, wherein determining, using the sensor data and Little's Law, a current average delay time at each Pull group comprises:
computing a standard deviation of the current delay time;
determining whether the standard deviation exceeds a predetermined acceptable threshold;
in response to determining that the standard deviation does not exceed the predetermined acceptable threshold:
computing a number of jobs in WIP using the sensor data; and
determining the current average delay time at each Pull group using Little's law and the computed number of jobs in WIP; or
in response to determining that the standard deviation does not exceed the predetermined acceptable threshold:
computing a number of jobs in WIP using a Pollaczek-Khintchine equation; and
determining the current average delay time at each Pull group using Little's law and the computed number of jobs in WIP.

14. The method of claim 1, wherein computing a current remaining lead time for a job using the collected sensor data and Little's Law further comprises:
determining, using the current remaining lead time, an estimated completion time for the job; and
comparing the estimated completion time for the job to a target completion time for the job to determine a current delay for the job.

15. The method of claim 14, wherein adjusting, based on the computed current remaining lead times, priorities at which the multiple jobs are processed by each Pull group comprises:
identifying one or more jobs that will not meet respective target completion times; and
assigning the identified one or more jobs higher processing priorities at one or more subsequent Pull groups.

16. The method of claim 1, wherein one or more of:
the number of multiple Pull groups is dependent on properties of the plurality of workstations, wherein the properties of the workstations comprise one or more of i) location of workstation, ii) an acceptable uninterrupted workstation runtime;
each Pull group is configured to receive a constrained number of days of work in progress per batch of parts, wherein the number of days depends on an average setup and machining time per part over each workstation in the Pull group; or
each workstation is associated with a set of performance parameters, the set comprising workstation setup time and part delivery time.

17. The method of claim 1, wherein collecting the sensor data, computing the current remaining lead times, and adjusting the priorities at which the multiple jobs are processed by each Pull group are performed by one or more local computers or by an external cloud service provider.

18. The method of claim 1, wherein the sensor data from a Pull group comprises i) data representing a number of jobs currently processed by or queued at the Pull group and ii) data representing a current rate of the number of jobs exiting the Pull group.

19. A system comprising:
one or more computers in data communication with a collection of workstations used to process multiple jobs or tasks;
a computer-readable medium coupled to the one or more computers having instructions stored thereon which, when executed by the one or more computers, cause the one or more computers to perform operations comprising:
processing multiple jobs using a plurality of workstations, wherein the plurality of workstations are grouped into multiple Pull groups, each Pull group comprising one or more workstations of a same type, the processing comprising, repeatedly, at each of multiple time steps until a predetermined condition is satisfied:
collecting, using sensors that monitor the plurality of workstations, sensor data from Pull groups in the multiple Pull groups;
computing, for each of the multiple jobs, a current remaining lead time using the collected sensor data and Little's Law; and
adjusting, based on the computed current remaining lead times, priorities at which the multiple jobs are processed by each Pull group.

20. One or more non-transitory computer-readable media having instructions stored thereon that, when executed by one or more processors, cause performance of operations comprising:
processing multiple jobs using a plurality of workstations, wherein the plurality of workstations are grouped into multiple Pull groups, each Pull group comprising one or more workstations of a same type, the processing comprising, repeatedly, at each of multiple time steps until a predetermined condition is satisfied:
collecting, using sensors that monitor the plurality of workstations, sensor data from Pull groups in the multiple Pull groups;
computing, for each of the multiple jobs, a current remaining lead time using the collected sensor data and Little's Law; and
adjusting, based on the computed current remaining lead times, priorities at which the multiple jobs are processed by each Pull group.

21. A computer-implemented method for processing multiple jobs or tasks, the processing comprising:
collecting, using sensors that monitor the multiple jobs or tasks in real time, sensor data from the multiple jobs or tasks; and
repeatedly, at each of multiple time steps:
calculating, for each of the multiple jobs or tasks and using the sensor data, a remaining lead time using Little's Law; and
adjusting, using the remaining lead times, priorities at which the multiple jobs or tasks are processed.

22. The method of claim 21, wherein the multiple jobs or tasks comprise jobs or tasks in a manufacturing process, supply chain, logistics, or new product development process.

23. A system comprising:
one or more computers; and
one or more computer-readable media coupled to the one or more computers having instructions stored thereon which, when executed by the one or more computers, cause the one or more computers to perform operations for processing multiple jobs or tasks, the operations comprising:
collecting, using sensors that monitor the multiple jobs or tasks in real time, sensor data from the multiple jobs or tasks; and
repeatedly, at each of multiple time steps:
calculating, for each of the multiple jobs or tasks and using the sensor data, a remaining lead time using Little's Law; and
adjusting, using the remaining lead times, priorities at which the multiple jobs or tasks are processed.

24. One or more non-transitory computer-readable media having instructions stored thereon that, when executed by one or more processors, cause performance of operations for processing multiple jobs or tasks, the operations comprising:
collecting, using sensors that monitor the multiple jobs or tasks in real time, sensor data from the multiple jobs or tasks; and
repeatedly, at each of multiple time steps:
calculating, for each of the multiple jobs or tasks and using the sensor data, a remaining lead time using Little's Law; and
adjusting, using the remaining lead times, priorities at which the multiple jobs or tasks are processed.

25. A computer-implemented method comprising:
receiving a request to produce a quantity of finished goods, wherein producing the quantity of finished goods comprises processing multiple jobs;
calculating, for each job of the multiple jobs and for each of multiple available factories, a remaining lead time using Little's Law;
selecting, based on the calculated remaining lead times and for each job of the multiple jobs, a factory with a lowest lead time; and
routing each job of the multiple jobs to a respective selected factory for processing.

26. The method of claim 25, wherein multiple factories share a lowest lead time, and wherein the method further comprises:
selecting, from the multiple factories that share the lowest lead time, a factory with a highest spare production capacity; and
routing the corresponding job of the multiple jobs to the factory with the highest spare production capacity for processing.

27. A system comprising:
one or more computers; and
one or more computer-readable media coupled to the one or more computers having instructions stored thereon which, when executed by the one or more computers, cause the one or more computers to perform operations comprising:
receiving a request to produce a quantity of finished goods, wherein producing the quantity of finished goods comprises processing multiple jobs;
calculating, for each job of the multiple jobs and for each of multiple available factories, a remaining lead time using Little's Law;
selecting, based on the calculated remaining lead times and for each job of the multiple jobs, a factory with a lowest lead time; and
routing each job of the multiple jobs to a respective selected factory for processing.

28. One or more non-transitory computer-readable media having instructions stored thereon that, when executed by one or more processors, cause performance of operations comprising:
receiving a request to produce a quantity of finished goods, wherein producing the quantity of finished goods comprises processing multiple jobs;
calculating, for each job of the multiple jobs and for each of multiple available factories, a remaining lead time using Little's Law;
selecting, based on the calculated remaining lead times and for each job of the multiple jobs, a factory with a lowest lead time; and
routing each job of the multiple jobs to a respective selected factory for processing.
